(19) United States
(12) Patent Application Publication
(10) Pub. No.: US 2013/0067368 A1
(43) Pub. Date: Mar. 14, 2013

(54) Apparatus, System, And Method Of Controlling Display Of User Interface, And Recording Medium Storing User Interface Display Control Program

(71) Applicant: Ayumi MIHARA, Kanagawa (JP)

(72) Inventor: Ayumi MIHARA, Kanagawa (JP)

(73) Assignee: RICOH COMPANY, LTD., Tokyo (JP)

(21) Appl. No.: 13/606,549

(22) Filed: Sep. 7, 2012

(30) Foreign Application Priority Data
Sep. 9, 2011 (JP) 2011-197204

(51) Int. Cl. G06F 3/048

(52) U.S. Cl. 715/764

(57) ABSTRACT

An apparatus, system, method, and a control program stored in a recording medium, each of which controls display of a user interface at a node in a workflow system, such that the user interface being displayed dynamically reflects various changes in the workflow system such as the change in one or more nodes in the workflow, the change in functionality of the node, or the change in functions authorized for use by a user or a group of users.

### CROSS-REFERENCE TO RELATED APPLICATIONS

This patent application is based on and claims priority pursuant to 35 U.S.C. §119 to Japanese Patent Application No. 2011-197204, filed on Sep. 9, 2011, in the Japan Patent Office, the entire disclosure of which is hereby incorporated herein by reference.

### BACKGROUND

1. Field

The present invention generally relates to a technique of controlling a user interface, and more specifically to an apparatus, system, method, and a control program stored in a recording medium each of which controls display of a user interface at a node in a workflow system that distributes electronic data from one node to the other node as defined by a workflow.

2. Background

The recent document distribution systems distribute electronic data among various apparatuses on a network according to a distribution rule that is previously set for specific electronic data. The distribution rule, which may be referred to as a workflow, may be set in the form of a structured document described in such as hypertext markup language (HTML) or extensible markup language (XML). The workflow defined by the structured document may be interpreted using Document Object Model (DOM) such that the apparatuses on the network apply processing as defined by the workflow to the electronic data. More specifically, at least a part of the apparatus that functions as one node in the workflow receives electronic data from the upstream node, applies specific processing to the received electronic data, and transfers the processed electronic data to the downstream node, according to the workflow.

The electronic data to be processed according to the workflow may be managed using bibliographic data of the electronic data such as a title, an author name, or a creation date of the electronic data, which may be previously entered by a user using a form. For example, FIG. 9 illustrates a structured document 900 that defines a form used for entering an encoding format as the bibliographic data. The structured document 900, which is written in XML, includes a tag defining a combo box, a tag defining data for generating the combo box, and a tag defining an item to be displayed on the combo box. Based on the structured document of FIG. 9, the node in the system displays a user interface that contains a combo box 1000 of FIG. 10. The combo box 1000, which is implemented as a pull-down list, displays data as defined by the structured document 900 of FIG. 9. The user may select one encoding format from the pull-down list, for example, by using a finger or a pointing device such as a mouse or stylus pen. FIG. 11 illustrates another example of a form, which allows the user to enter the bibliographic data of the electronic data to be processed according to the workflow.

While the user is able to enter bibliographic data using a form as illustrated in FIG. 9 or 11, the structured document that defines the form is previously set irrespective of characteristics of the workflow to be processed, such that the form used for entering the bibliographic data cannot be freely changed.

Japanese Patent Application Publication No. 2009-044723 describes a screen generating method of generating an input screen for setting metadata. In the screen generating method, a client device receives input for designing an item for setting metadata on a generating screen, generates definition data of the input screen based on a descriptor that is arbitrary determined by a user for displaying the item on the input screen and the item designated on the generating screen, and transmits the definition data to an image forming apparatus for display. While this screen generating method allows the user to design an item for setting metadata through the client device, the item for setting metadata that has been set by the user may not be always compatible to some apparatuses on the network, as some apparatuses on the network may change their functionality.

### SUMMARY

In view of the above, one aspect of the present invention is to provide an apparatus, system, method, and a control program stored in a recording medium, each of which controls display of a user interface at a node in a workflow system that distributes electronic data from one node to the other node as defined by a workflow, such that the user interface dynamically reflects various changes in the workflow system, such as the change in one or more nodes in the workflow, the change in functionality of the node, or the change in functions authorized for use by a user or a group of users.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is an illustration for explaining a workflow that defines processing to be performed on electronic data, according to an example embodiment of the present invention;

FIG. 2 is a schematic block diagram illustrating a workflow system, which performs processing according to the workflow of FIG. 1, according to an example embodiment of the present invention;

FIG. 3 is a schematic block diagram illustrating a functional structure of a server of the network system of FIG. 2, according to an example embodiment of the present invention;

FIG. 4 is an example data structure of authorized function information stored in a database provided for the server of the workflow system of FIG. 2;

FIG. 5 is a flowchart illustrating operation of generating user interface (UI) data, performed by the server of the workflow system of FIG. 2, according to an example embodiment of the present invention;

FIG. 6 is example UI data generated by the server of the workflow system of FIG. 2;

FIG. 7 is a flowchart illustrating operation of displaying a user interface based on UI data received from the server of the workflow system of FIG. 2, performed by one of clients of the workflow system of FIG. 2, according to an example embodiment of the present invention;

FIG. 8 is an example user interface, which is displayed by one of the clients of the workflow system of FIG. 2 based on UI data received from the server of the workflow system of FIG. 2;

FIG. 9 is an illustration for explaining an example structured document for generating a form, according to the background art;

FIG. 10 is an illustration for explaining an example combo box, which is displayed based on the structured document of FIG. 9, according to the background art; and

FIG. 11 is an illustration for explaining an example user interface including a form, according to the background art.

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

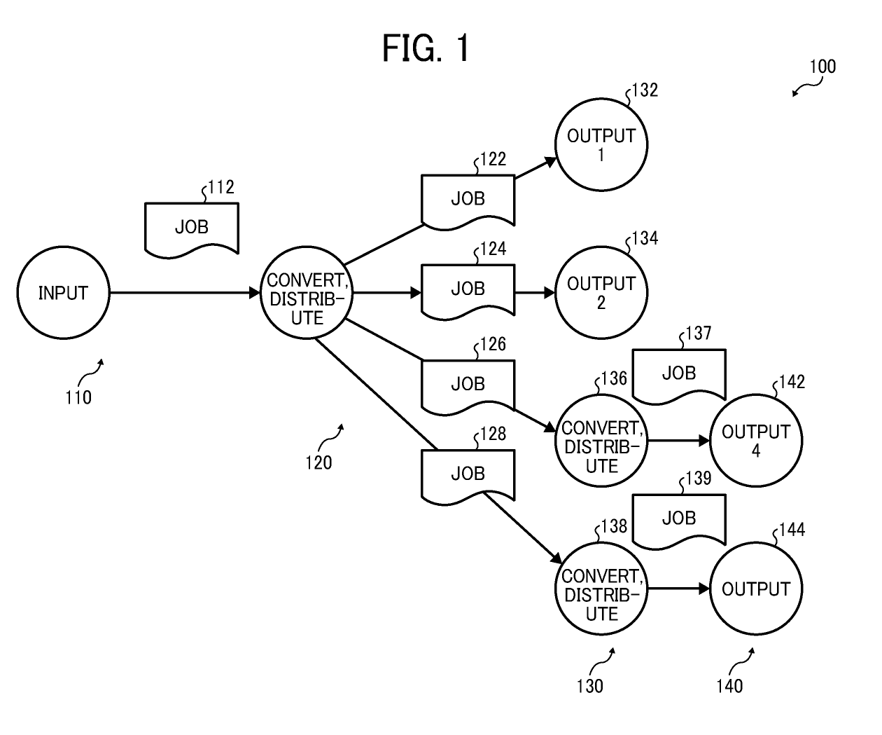

Referring now to FIGS. 1 to 8, an apparatus, system, method, and control program stored in a recording medium, each of which is capable of controlling display of a user interface at a node in a workflow system are explained according to example embodiments of the present invention.

FIG. 1 illustrates a workflow 100, which may be performed by any desired workflow system in which a plurality of nodes are provided to apply processing as defined by a workflow. As illustrated in FIG. 1, the workflow 100 controls a flow of jobs from a first node to a last node with respect to electronic data to be processed. In one example, each node in the workflow 100 corresponds to any part of hardware and/or software resources of one or more devices or apparatuses, which may be connected through any desired network including a bust line, the Internet, or a local area network (LAN). For example, each node in the workflow 100 may be implemented by a set of software components that adds specific functionality to the existing application, such as a plug-in or add-on. With this added functionality, each node in the workflow 100 may perform specific processing as defined by the workflow 100. Examples of specific processing include, but not limited to, scanning, image format conversion, image compression, electronic data transmission, printing, and storing. As the electronic data is processed at one node, the processed electronic data is further transmitted to the downstream node using a transmission protocol that is compatible to the downstream node. This process of applying processing and transferring with respect to the electronic data is repeated until the workflow is completed.

Referring to FIG. 1, at a first node 110 where the workflow 100 is started, electronic data to be processed is input, for example, by a scanner or a facsimile unit of a multifunctional product (MFP). At the first node 110, a user may enter bibliographic data relating to the electronic data, for example, using a user interface (UI) displayed through the MFP. Alternatively, the bibliographic data may be obtained, for example, by the MFP as the electronic data is input at the first node 110. Examples of the bibliographic data include, but not limited to, author identification information such as the name of an author who creates the electronic data, the date/time at which the electronic data is created, organization information relating to an organization to which the author belongs such as the place where the organization is located, information indicating authorized use of the electronic data by different groups of users, size information regarding a file size of the electronic data, destination information regarding a destination to which the electronic data is transmitted. The bibliographic data, which may be entered by the user, is managed in association with the electronic data. Further, the electronic data to be processed is managed in association with workflow settings data defining the workflow to be applied to the electronic data, which includes information indicating a group of nodes to perform specific processing or parameter values to be used by each node in the workflow.

The electronic data, which may be sent together with the bibliographic data and the workflow settings data, is transmitted to a second node 120 through a network as a job 112. In this example, the second node 120 refers to the bibliographic data and/or the workflow settings data, and converts a file format of the electronic data and/or a transmission protocol of the electronic data based on information obtained from the bibliographic data and/or the workflow settings data. Examples of conversion include, but not limited to, OCR processing and PDF conversion. The electronic data, which may be converted, is transmitted from the second node 120 to a third node 130. More specifically, the second node 120 obtains information regarding the third node 130, such as information regarding a distribution rule to specify a destination apparatus or information regarding a transmission protocol compatible to the destination apparatus using the bibliographic data and/or the workflow settings data. Examples of information regarding the transmission protocol include, but not limited to, an IP address, a node name, and an email address of the destination apparatus. Based on the information obtained from the bibliographic data and/or the workflow settings data, the second node 120 specifies one or more destination apparatuses at the third node 130, and transmits the job 112 to the third node 130. In this example, the job 112 is transmitted to a plurality of nodes 132, 134, 136, and 138 of the third node 130, which is downstream, as a job 122, a job 124, a job 126, and a job 128. The jobs 122 to 128 each include the electronic data processed by the second node 120, the bibliographic data, and the settings data.

In this example illustrated in FIG. 1, the third nodes 132 and 134 respectively function as output nodes that respectively output electronic data of the job 122 and job 124. Further, in this example, outputting does not only correspond to printing an image based on electronic data of the job 122 or the job 124 onto a recording sheet, but also correspond to storing electronic data of the job 122 or the job 124 in a target memory area such as in a target folder of a file system, or transmitting electronic data of the job 122 or the job 124 with email data to a specific destination. The third nodes 136 and 138 may respectively convert electronic data of the job 126 and job 128 to generate converted electronic data as a job 137 and a job 139. The third nodes 136 and 138 transmit the job 137 and the job 139, respectively, to a fourth node 142 and a fourth node 144 of a fourth node 140. Further, at the third node 130, the user may enter any desired data relating to the electronic data as bibliographic data, which is to be added or replaced with the bibliographic data. At the fourth node 140, the fourth nodes 142 and 144 function as output nodes that output electronic data of the job 137 and the job 139, respectively.

In this example, the workflow 100 may be set by a server apparatus, which manages a workflow system that performs various processing as defined by the workflow according to a user instruction. For example, the server apparatus sets a flow of jobs from the first node 110 to the last node 140, such as by defining a specific node to apply specific processing, a parameter value to be used by the specific node, and a transfer protocol used for transmitting the job from one node to another. Such data defining the workflow is transmitted to the first node 110 as the workflow settings data, which may be written in a structured document. Further, the workflow settings data may be stored in a memory of the server.

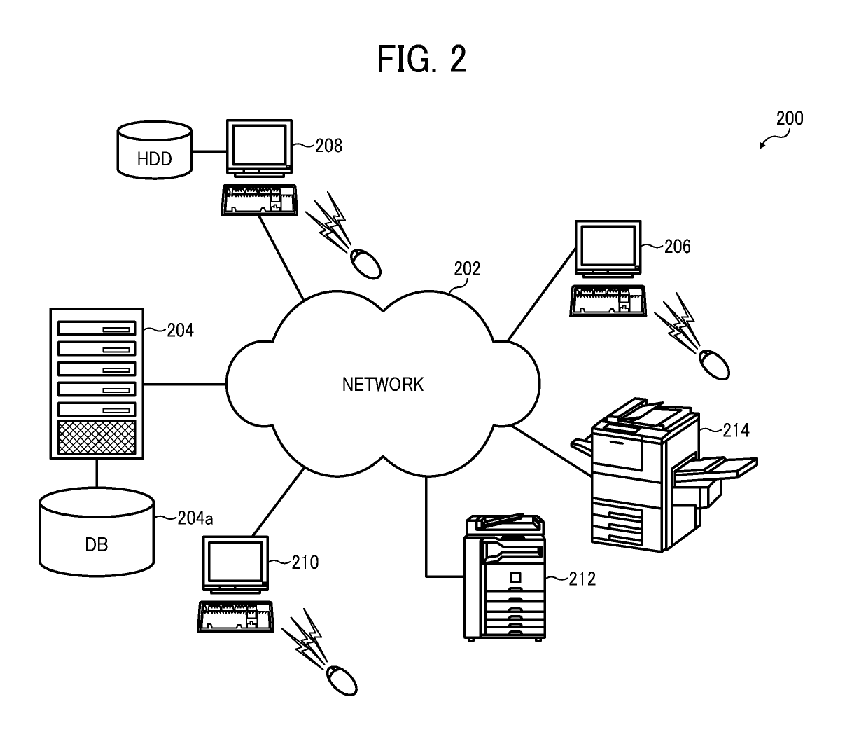

FIG. 2 illustrates a schematic block diagram illustrating a network system 200, which is capable of performing processing as defined by a workflow, such as the workflow 100 of FIG. 1. The network system 200 includes a plurality of devices or apparatuses that are connected through a network 202, which together function as a workflow system that performs processing as defined by the workflow. The network 202 may be implemented by the Internet and/or a local area network (LAN), which may be connected through a network device such as a router or a hub. For the descriptive purposes, the network system 200 may be alternatively referred to as the workflow system 200.

The network system 200 includes a server 204 that manages the workflow, image processing apparatuses 212 and 214, and information processing apparatuses 206, 208, and 210. The server 204 functions as a web server, which may be implemented by a personal computer. The server 204 includes a processor such as a Pentium (registered trademark) based processor, a Complete Instruction Set Computer (CISC) chip, or a Reduced Instruction Set Computer (RISC) chip. The server 204 further includes a memory such as a read only memory (ROM), a random access memory (RAM), and a hard disk drive (HDD). The server 204 is installed with an operating system (OS) such as UNIX (registered trademark), LINUX (registered trademark), or Windows (registered trademark). The processor of the server 204 executes a web server program, such as Apache (registered trademark) or IIS (registered trademark) under the OS to cause the server 204 to function as the web server.

The processor of the server 204 executes a control program, which may be written by a programming language such as Java (registered trademark), JavaScript (registered trademark), Perl, Ruby, Python, or PHP, to provide a Common Gateway Interface (CGI). With the CGI, the server 204 provides various services to the outside apparatuses functioning as a client, through the network 202.

The server 204 is further provided with a structured document dictionary, which is used to extract a structured document element for each one of one or more functions that are authorized for use by a user. When the server 204 receives a request for generating a workflow from the user, the server 204 obtains user information of the user, determines one or more functions of the workflow system that are authorized for use by the user, and specifies a structured document element indicating the function that is authorized for use by the user for each of the authorized functions. The server 204 reads the specified structured document element along with attribute description. The server 204 generates a XML-based structure using the obtained structure document element with the attribute description, and returns the XML-based structure to a client that sends the user request to allow the user to define a workflow based on the structured document.

The image processing apparatus 212 may be implemented by any desired image forming apparatus provided with an image forming engine, such as a scanner, copier, printer, facsimile, or a multifunctional peripheral (MFP) capable of providing a plurality of functions of scanning, printing, transmitting or receiving facsimile data or email data, storing electronic data, etc.

For example, the image processing apparatus 212 may be implemented by a MFP, which includes a processor, a memory, an operation panel, a communication device, a scanner engine, and a printer engine. The processor controls entire operation of the MFP. The memory stores therein various data such as control programs to be executed by the processor to perform operation. The operation panel receives various data from the user or displays various data to the user. The communication device allows transmission or reception of data to or from the outside apparatus such as the server 204. The scanner engine scans an original image into electronic data, and may function as an input node in the workflow system. The printer engine prints an image on a recording sheet, and may function as an output node in the workflow system.

The image processing apparatus 214 may be implemented by any desired image forming apparatus such as a MFP in a substantially similar manner as described above referring to the case of image processing apparatus 212. In this example, the image processing apparatus 214 is provided with a function of transmitting or receiving image data via facsimile in compliance with G3 or G4 facsimile protocol through a public switched telephone network (PSTN), or a function of transmitting or receiving image data via the network 202. For example, the facsimile communication function may be implemented by a facsimile control unit, and the network communication function may be implemented by a communication device.

The image processing apparatus 212 and the image processing apparatus 241 may each function as a client with respect to the server 204. More specifically, in this example, any one of the image processing apparatus 212 and the image processing apparatus 241 functions as one or more nodes in the workflow to process specific function as defined by the workflow constructed by the server 204.

The information processing apparatuses 206, 208, and 210 are each implemented by a personal computer, which functions as a client with respect to the server 204. Further, the information processing apparatuses 206, 208, and 210 may each function as a storage that stores the job transferred from the image processing apparatus 212 or 214. More specifically, in this example, any one of the information processing apparatuses 206, 208, and 210 functions as one or more nodes in the workflow to process specific function as defined by the workflow constructed by the server 204.

For example, the information processing apparatuses 206 to 210 are each provided with at least a processor, a memory, an input device, and a display device. The processor controls entire operation of the information processing apparatus. The memory stores therein various data such as a control program to be executed by the processor to perform operation. The input device allows a user to input various data using a keyboard or a mouse. The display device, which may be implemented by a liquid crystal display (LCD), displays various data to the user.

The image processing apparatuses 212 and 214 and the information processing apparatuses 206 to 210 are each provided with browser software, such as the Internet Explorer (registered trademark), Mozilla (registered trademark), Opera (registered trademark), Firefox (registered trademark), or Chrome (registered trademark). With the browser, the apparatuses 206, 208, 210, 212, and 214 functioning as the client (collectively referred to as “the client”) each parses a structured document written in a predetermined language such as XML or HTML to interpret the structured document, and causes the display to display a graphical user interface based on the structured document. More specifically, when the browser is executed, the processor of the client is provided with a XML parser, which interprets the structured document described in XML as a data object using such as a document object model (DOM). For example, the XML parser integrates a plurality of structured documents using a description format, such as a Document Type Definition (DTD) or Cascading Style Sheet (CSS), XML Style Sheet (XSLT), XLS schema, or namespace, to generate a user interface (UI) based on the structured documents. The UI is then displayed to the user. In this example, any part of UI data may be added as a patch or a plug-in, thus providing seamless UI display.

In example operation, the server 204 defines a workflow using the structured document that is described in, for example, XML. The client receives the structured document defining the workflow as the workflow settings data through the network 202, and applies specific processing to electronic data input to the system as one node in the workflow. When the client receives the structured document defining the workflow, i.e., the workflow settings data, the client interprets each tag in the structured document, and determines specific processing to be applied to the electronic data. Further, in this example, the client allows the user to enter bibliographic data relating to the electronic data, through a user interface displayed by the display. More specifically, the processor of the client generates a user interface based on a structured document defining a user interface specific to the client or the user at the client, and displays the user interface through the display. The client may transmit the bibliographic data, which is entered by the user at the client through the user interface, to the server 204 or the downstream node, for example, in the form of structured document.

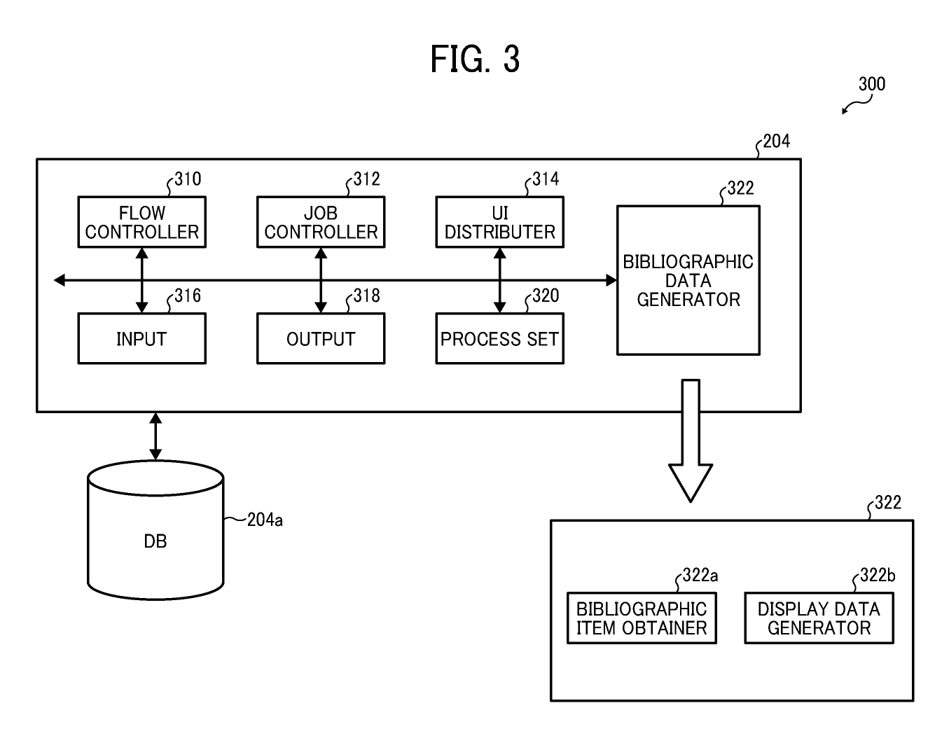

FIG. 3 is a schematic block diagram illustrating a functional structure 300 of the server 204, according to an example embodiment of the present invention. The server 204 executes a server program to cause hardware resources of the server 204 to have functional blocks as illustrated in FIG. 3. In this example, the server program includes a control program, which causes the server 204 to generate UI data specific to each client functioning as one node in the workflow system.

The server 204 includes a flow controller 310, a job controller 312, a UI distributer 314, an input 316, an output 318, a processing set 320, and a bibliographic data generator 322. The server 204 is further connected with a database (DB) 204a.

The flow controller 310 defines a workflow to be executed by a network system, such as the workflow 100 of FIG. 1 processed by the workflow system 200 of FIG. 2. The workflow may be specified by a specific name or an identifier such that each workflow is uniquely identified. In one example, when the server 204 receives a user request for generating a workflow from the information processing apparatus 206, the flow controller 310 of the server 204 refers to a desired data format of the workflow that may be provided from the user, or information indicating authority of the user, to generate a structured document using, for example, a XML editor. The generated structured document defines the workflow to be processed by the workflow system 200. The workflow defined by the flow controller 310 is stored in a memory of the server 204, such as in the database 204a.

The job controller 312 receives status information indicating the status in executing the workflow defined by the flow controller 310, from each node of the workflow through the network 202. The job controller 312 refers to the received status information to determine whether to change the node in the workflow so as to avoid interruption to the workflow.

The input 316 receives input from the outside apparatus, for example, by managing an input device. The output 318 outputs a result to the outside apparatus, such as through displaying the result. The UI distributor 314 distributes UI data, which is generated by the bibliographic data generator 322, and UI control data to a specific node in the workflow.

The processing set 320 extracts an element that describes specific processing to be executed by each node of the workflow specified by the flow controller 310, from the workflow settings data stored in the database 204a, and provides the extracted element to the flow controller 310.

The bibliographic data generator 322 generates a structured document, which defines one or more UI parts to be included in a UI based on one or more bibliographic data items that are specific to each node, and causes each node in the workflow to display the UI based on the generated UI data. Examples of the bibliographic data items that may be specific to each node include, but not limited to, a document name, address information, a document number, date/time information, and authorization information. For example, assuming that each node corresponds to each device in the workflow system, the bibliographic data generator 322 generates UI data that defines one or more UI parts, which reflect one or more bibliographic data items that are specific to each device.

FIG. 3 further illustrates an example structure of the bibliographic data generator 322. The bibliographic data generator 322 includes a bibliographic item obtainer 322a and a display data generator 322b. The bibliographic data obtainer 322a extracts one or more bibliographic data items to be set for a specific node of the workflow, from the database 204a, using node information. The node information includes any desired information regarding a device or an apparatus functioning as a node in the workflow. For example, the node information indicates authorized function information regarding one or more functions of a specific device that are authorized for use by a user or a group of users, a device type, and availability or capability of the device such as sorter capability, stapler capability, facsimile capability, scanner capability, email capability, or file transfer capability. The server 204 may collect the node information from each node at any desired time, and store the obtained node information in the database 204a. The node information may be stored in association with node identification information that uniquely identifies a node. As described below, the node information is used to set one or more bibliographic data items that are specific to each node.

The display data generator 322b refers to the node information such as the authorized function information indicating one or more functions of a specific node that are authorized for use, specifies one or more bibliographic data items that reflect the one or more authorized functions, and generates UI data that causes each node to display a UI including UI parts that reflect the obtained bibliographic data items. For example, the UI data may be generated in the form of XML schema using XML editor. Further, the UI data, or the structured document, generated by the display data generator 322b is added with attribute description that sets values for controlling attributes according to the authorized functions of the node. The display data generator 322b refers to the node information such as the authorized function information indicating the authorized functions of a specific node, which is stored in the database 204a, and generates UI control data that controls the UI display at the specific node. The UI control data may be written in XSLT, which converts the structured document in XML into HTML for display as a user interface. For example, assuming that a group of nodes each being authorized to use a specific function is defined as a set of variables, the UI control data has a structure that lists the nodes each being one element of the group. The UI control data may be assigned with a specific space name such that the UI control data with a specific space name may be used as a standardized variable in the system.

In example operation, when the server 204 receives a request for UI data from a node (“request node”), the server 204 determines whether the request node is new to the workflow, and distributes the UI data to the request node when it is determined that the request node is new. Based on the UI data, the request node generates a UI that reflects the node information such as the authorized functions of the request node.

When it is determined that the request node is not new, the server 204 determines whether the authorized functions of the request node are updated, and sends notice indicating that the authorized functions of the request node are not updated to the request node when it is determined that the authorized functions of the request node are not updated. In such case, the request node continues to display a UI based on the UI data that is previously received from the server 204.

When it is determined that the authorized functions of the request node are updated, the server 204 generates UI control data that controls parts of the UI data to be displayed by the request node so as to reflect the updated authorized functions, and distributes the UI control data to the request node. The request node displays a UI based on the UI control data so as to reflect the changes.

In this example, the UI data is generated as XML schema such that addition or combination of parts in the UI data can be made easier at any desired time, for example, by defining a namespace.

As described above, the server 204 dynamically generates UI data specific to each node in the workflow, and causes each node to display a UI through which bibliographic data items specific to each node can be set. The server 204 may transmit the UI data or the UI control data in response to a request received from a specific node. Alternatively, when the server 204 detects any change in the authorized functions of a specific node, the server 204 updates the UI control data to reflect the changes, and transmits the updated UI control data to the specific node to cause the specific node to display a UI to reflect the changes. Alternatively, the server 204 may periodically update the UI control data for each node, and distributes the UI control data to each node in the workflow system. The UI control data may further include any desired type of the node information such as a device type of the node or optional functions to be performed at the node.

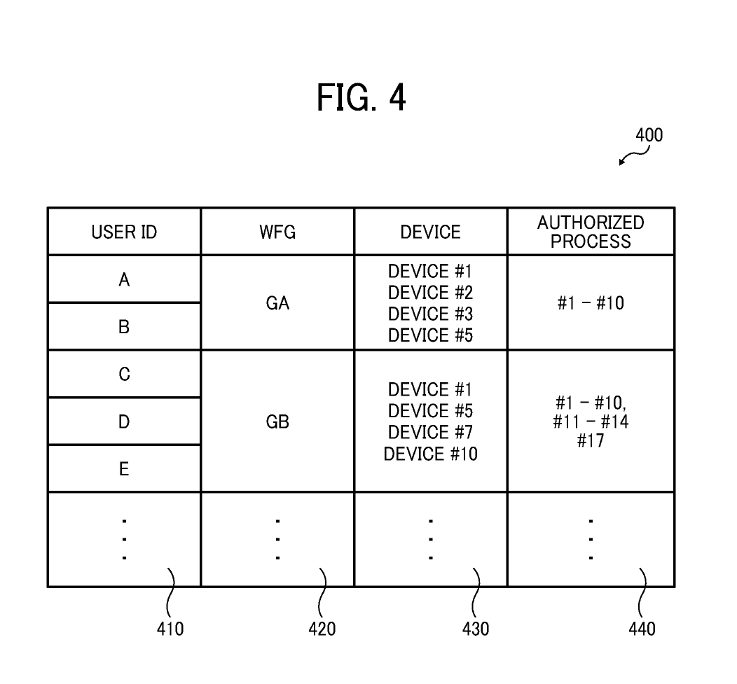

Referring now to FIGS. 4 to 8, operation of generating UI data and/or UI control data, which reflects functions of a specific node that are authorized to a group of users is explained according to an example embodiment of the present invention.

FIG. 4 illustrates an example data structure of the authorized function information of the node information, which is stored in the database 204a of the server 204. The authorized function information includes a column 410 storing user identification information that uniquely identifies a user such as a user ID, a column 420 storing group identification information that uniquely identifies a workflow group to which the user belongs (“WFG”), a column 430 storing information indicating a list of devices assigned to the workflow group, and a column 440 storing information indicating one or more processes or functions of the devices that are authorized for use by the user.

More specifically, the user ID stored in the column 420 corresponds to each one of the users who are registered to at least one of a plurality of devices that are managed by the server 204. The workflow group corresponds to a specific workflow that is previously set, and is used to specify a group of users who are expected to use the specific workflow that is previously set. For example, the workflow group “GA” may correspond to the “scan to mail” function, which performs a sequence of processing including scanning a paper document into electronic data and transmitting the electronic data to a destination by email. The user A and the user B are registered as potential users of the workflow “scan to mail”.

The device information stored in the column 430 lists a plurality of devices #1, #2, #3, and #5, each of which functions as one or more nodes in the workflow to perform specific processing. For example, assuming that the workflow group “GA” performs “scan to mail”, any one or more devices including a scanner that scans the paper document, a converter that converts the scanned data into email data, and a distributor that distributes the email data to a destination may be specified in the workflow system. As described above, each node in the workflow may be any part of hardware and/or software resources available in the workflow system. The device specified by the device information stored in the column 430 may correspond to one machine such as a MFP or any device provided in the machine, which may operate in cooperation with software.

The authorized functions (“authorized process”) stored in the column 440 indicates one or more functions, or processes, which are available to one or more devices specified in the column 430 and authorized for use by the user. In this example, the authorized functions of one or more devices are set by workflow group. For the user A and the user B who belong to the WFG “GA”, the functions #1 to #10 are authorized for use. For the users C, D, and E who belong to the WFG “GB”, the functions #1 to #10, #11 to #14, and #17 are authorized for use. Alternatively, the authorized functions in column 440 may be set based on processing capability of each device that can be obtained from the node information, in addition to the authorized functions that are authorized to a user who belongs to the workflow group.

In this example illustrated in FIG. 4, the server 204 generates UI control data, which causes each node to display a UI such that the users A and B of the WFG “GA” only see bibliographic data items corresponding to the functions #1 to #10. More specifically, when the client functioning as a node determines that the user A or B is logged on, the client displays a UI, which includes only the UI parts that reflect bibliographic data items that are associated with the functions that are authorized and available to the user A or B.

In this manner, the server 204 dynamically generates UI control data, which reflects various changes in the workflow system, such as the change in a set of devices that perform processing in the workflow, the change in functionality or capability of the device, and the change in one or more functions of the device that are authorized for use by the user. The server 204 sends the UI control data to a specific node to cause the specific node to display a UI generated based on the UI control data. Accordingly, each node does not have to modify a structured document to update the UI parts included in the UI. For example, even when the functionality of an information processing apparatus in the workflow system is extended, for example, by adding a plug-in or add-on program, a UI to be displayed at each node in the workflow system can reflect such changes with improved efficiency.

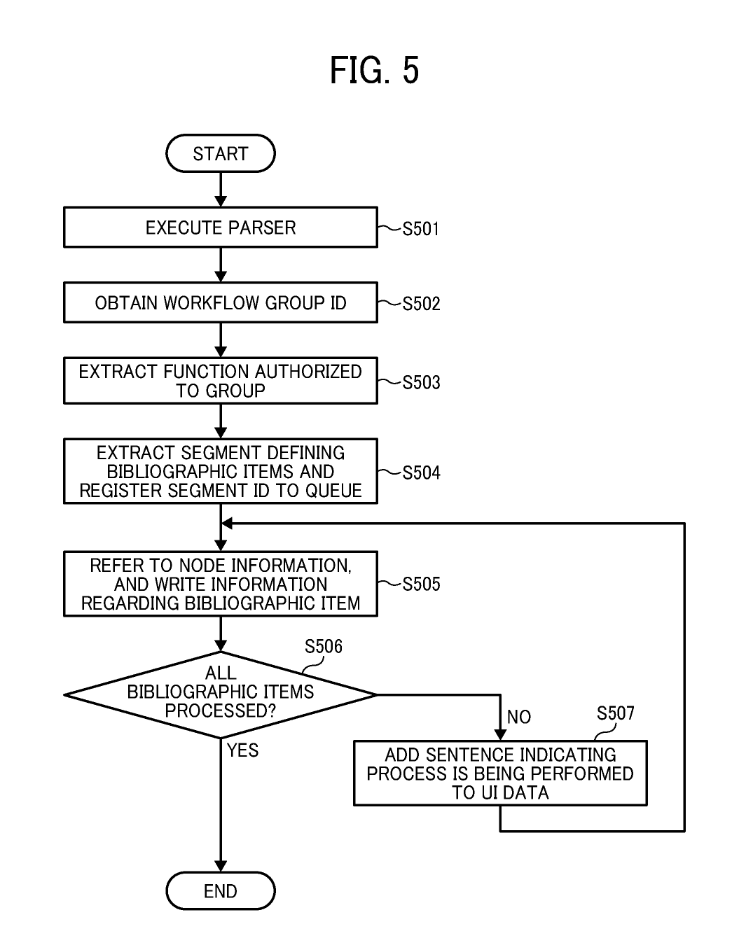

FIG. 5 is a flowchart illustrating operation of generating UI data, performed by the server 204, according to an example embodiment of the present invention. In this example, it is assumed that the server 204 generates UI data to be displayed at a node, in a manner that is specific to a workflow group. The operation of FIG. 5 is performed by the processor in cooperation with the control program stored in the memory, which operates as the bibliographic data generator 322 (FIG. 4).

At S501, the server 204 calls the XML parser to cause the XML parser to start operation of generating UI data in XML.

At S502, the server 204 refers to the database 204a to obtain group identification information indicating a workflow group to which a specific workflow is assigned. At S503, the server 204 extracts one or more functions that are authorized for use by the workflow group that is specified at S502. For example, assuming that the workflow that is associated with the workflow group “GB” is to be processed, the bibliographic data generator 322 of the server 204 obtains the group identification information “GB”, and extracts the authorized functions or processes #1 to #10, #11 to #14, and #17, using the authorized function information stored in the database 204a.

At S504, the bibliographic data generator 322 of the server 204 extracts a structured document segment, which defines one or more bibliographic data items to be used for each one of the authorized functions extracted at S503 in either a sentence or a paragraph. The server 204 registers segment identification information for identifying the extracted segment, such as a segment ID, to a queue. As described above, the structured document segment may be stored in the structured document dictionary in the database 204a. For example, the server 204 may be provided with association information indicating the association between a structured document segment defining one or more bibliographic data items, and one or more authorized functions. Using this association information, the structured document segment defining one or more bibliographic data items may be specified using the authorized function of the authorized function information of FIG. 4.

At S505, the bibliographic data generator 322 of the server 204 refers to node information of a specific node such as node identification information, and adds the node information to a head section of the extracted structured document segment as an attribute value indicating a specific node, for example, together with the group identification information. In this manner, the structured document segment that defines one or more bibliographic data items can be associated with a specific node that belongs to a specific workflow group. The node identification information and the group identification information may be each defined using a namespace, such that data can be used or freely added with a segment even among different UI data.

At S506, the bibliographic data generator 322 of the server 204 determines whether the structured document segments each defining the bibliographic data items, which are registered to the queue, have been all processed. When it is determined that all of the structured document segments registered to the queue are processed (“YES” at S506), the operation ends. The bibliographic data generator 322 of server 204 stores the structured document segments, which are assigned with the group and node identification information, in the database 204a as UI data. The UI data may be assigned with any desired name or identification information.

When it is determined that there is at least one structured document segment that is not processed (“NO” at S506), the operation proceeds to S507. At S507, the bibliographic data generator 322 of server 204 adds a sentence indicating that processing is taking place at the end of the UI data including the structured documents that have been generated. The operation further returns to S505 to repeat S505 and S506, until all structured document segments defining the bibliographic items, which are registered to the queue, are processed.

As described above, the server 204 generates UI data, which defines the UI parts that reflect one or more bibliographic data items of the authorized functions that are available to a specific node and are authorized for use by a specific user or a specific group of users. The UI data may be generated in a structured document using XML schema. When new processing is added to the workflow, the server 204 may freely change the UI part in the UI, for example, by adding a segment to the end of the UI data, the head of the UI data, or any location between the head and end of the UI data.

Any one of the image processing apparatuses 212 and 214, and the information processing apparatus 206 to 210, which receives the UI data in XML schema, executes the XML parser to interpret attribute values of the UI data to control the UI display.

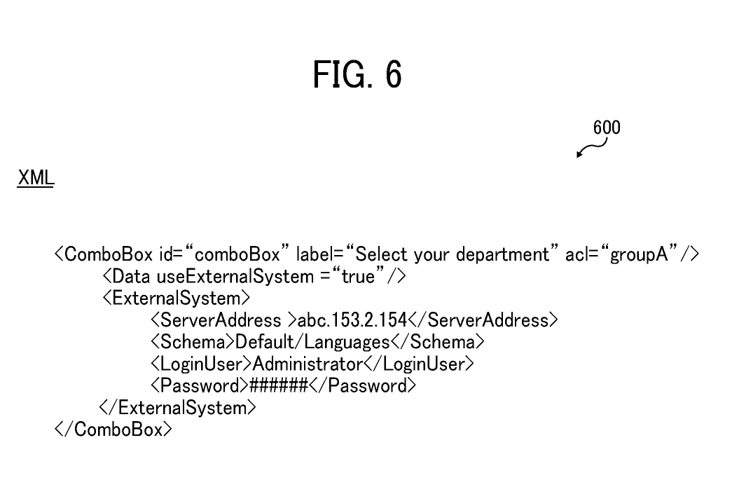

FIG. 6 illustrates example UI data 600, which is generated by the server 204. The UI data 600 of FIG. 6 defines a user interface to be displayed at a specific node in the workflow, which belongs to the workflow group “A”. As illustrated in FIG. 6, the UI data 600, which is written in XML, includes a <ComboBox> tag in which the authorization attribute (=acl) is set with a value “groupA”. The value “groupA” may be previously set by an administrator of the system through a screen that can be accessed by only the administrator, and stored in a nonvolatile memory of the node.

The UI data of FIG. 6 further includes a tag <ExternalSystem>, which indicates that the UI control data for displaying the UI requires the node to access the server 204 having the IP address of “adc.153.2.154”. The tag <ExernalSystem> further describes a user ID and a password of the login user. The login user information, which is input in the tag <ExternalSystem>, may be previously sent to the server 204.

The server 204 searches the authorized function information stored in the database 204a using the user ID obtained from the tag <ExernalSystem> as a search key to specify a workflow group “WFG” of the login user and one or more authorized functions that are available to and authorized to the specified workflow group. The server 204 further extracts one or more bibliographic data items, which are associated with the authorized functions, to generate UI control data that defines the UI parts reflecting the extracted bibliographic data items in the form of XML schema. The server 204 further transmits the UI control data to the node to cause the node to display a user interface based on the UI control data. Each workflow group “WFG” may be assigned with a specific namespace, such that the user interface or the workflow may be managed by workflow group.

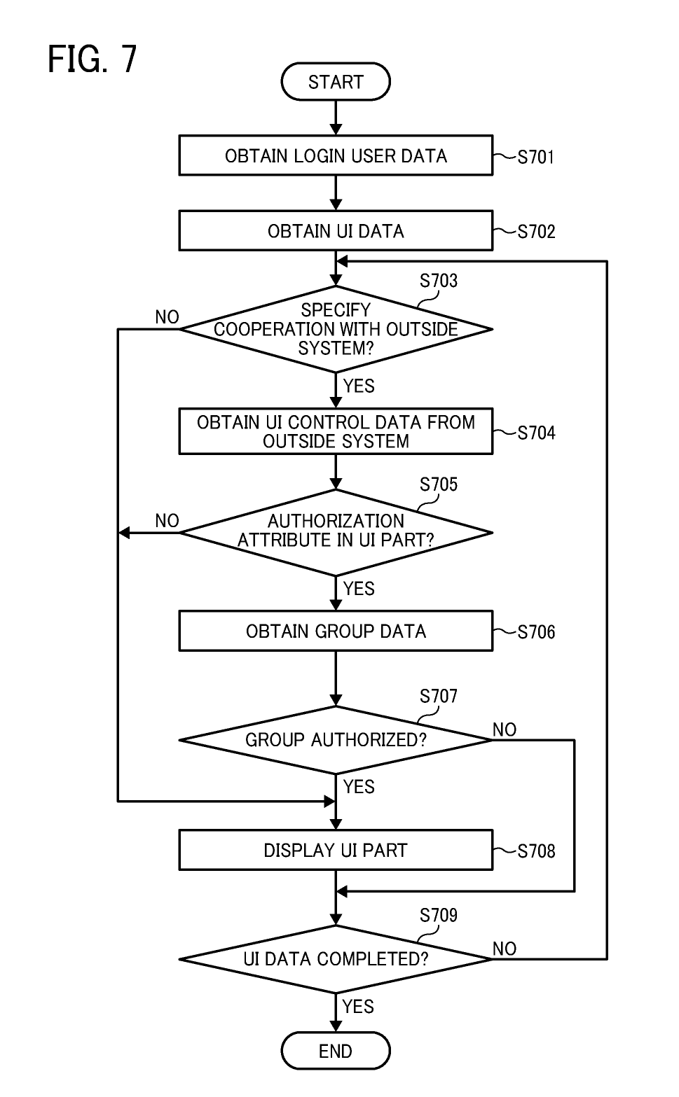

FIG. 7 is a flowchart illustrating operation of displaying a user interface at the node of the workflow group, performed by the node, according to an example embodiment of the present invention. The operation of FIG. 7 may be performed by a processor, which operates in cooperation with a control program to function as a XML parser and a browser. Further, in this example, the node is assumed to be any one of the apparatuses in the workflow system 200 functioning as the client.

At S701, the client obtains login user information from the user, which includes, for example, a user name and a user password.

At S702, the client accesses the server 204 to obtain UI data, for example, by transmitting a request for UI data to the client together with the login user information obtained at S701. Alternatively, when the client has obtained the UI data from the server 204, the client may read out the UI data from a cache memory. When the UI data is obtained, the client performs S703 to S709 for each UI part of the UI data to determine the UI parts to be displayed.

At S703, the client checks a tag in a UI part of the UI data, and determines whether to perform UI control in cooperation with the outside system. For example, referring to FIG. 6, the client checks the tag <DatauseExternalSystem> and determines whether the value is “true” or “false”. When it is determined that there is no tag indicating cooperation with the outside system (“NO” at S703) or the value of tag <DatauseExternalSystem> is false, the operation proceeds to S708. At S708, the client determines to display the UI part included in the UI data.

When it is determined that there is a tag indicating cooperation with the outside system (“YES” at S703) such that the value of tag <DatauseExternalSystem> is true, the operation proceeds to S704. At S704, the client obtains UI control data from the server 204, for example, by sending a request for UI control data to the server 204.

At S705, the client interprets the UI control data using the XML parser to determine whether the UI control data includes an attribute relating to authorization. When the UI control data includes the attribute relating to authorization (“YES” at S705), the operation proceeds to S706. At S706, the client obtains group identification information that is specified by the attribute of the UI control data.

When it is determined that the UI control data does not include the attribute relating to authorization (“NO” at S705), the operation proceeds to S708. At S708, the client determines to display the UI part included in the UI data.

At S707, the client selects one of the UI parts in the control data to be processed, and determines whether the group identified by the group identification information is authorized to access the UI part corresponding to one or more bibliographic data items. That is, the client determines whether the bibliographic data items of the UI part corresponds to the authorized functions of the group. When it is determined that the group is authorized to access the UI part (“YES” at S707), at S708, the client determines that the UI part is to be included in the UI for display.

When it is determined that the group is not authorized to access the UI part (“NO” at S707), the client determines that the UI part is not to be included in the UI, and the operation proceeds to S709.

At S709, the client determines whether all the UI parts included in the UI data are processed. When it is determined that there is at least one unprocessed UI part (“NO” at S709), the operation returns to S703 to repeat S703 to S709. When it is determined that all of the UI parts in the UI data are processed (“YES” at S709), the operation ends.

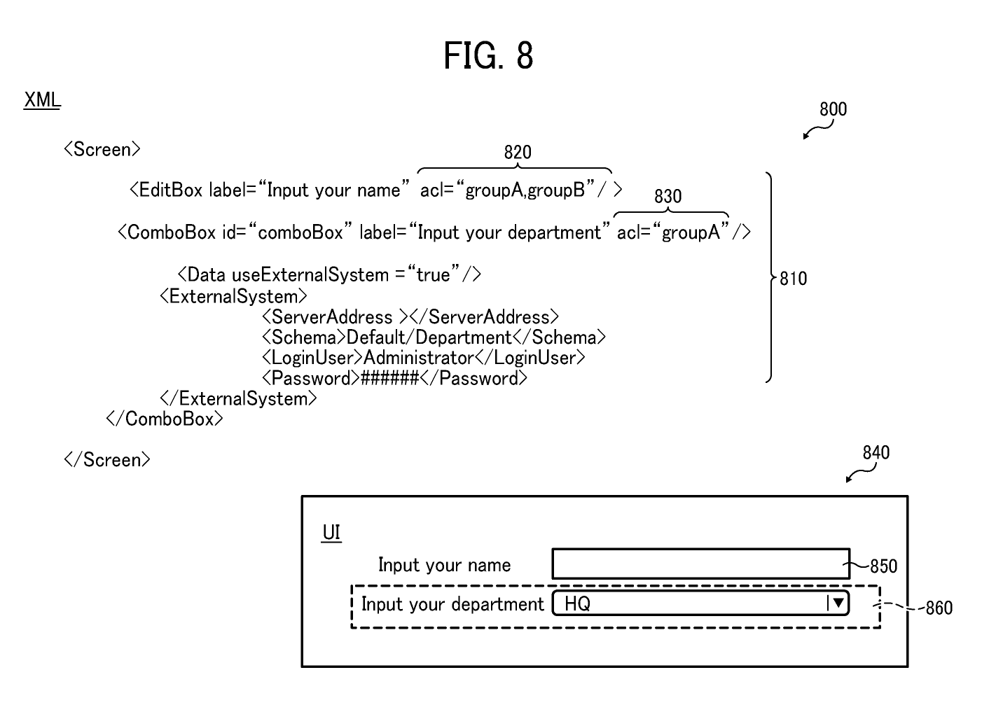

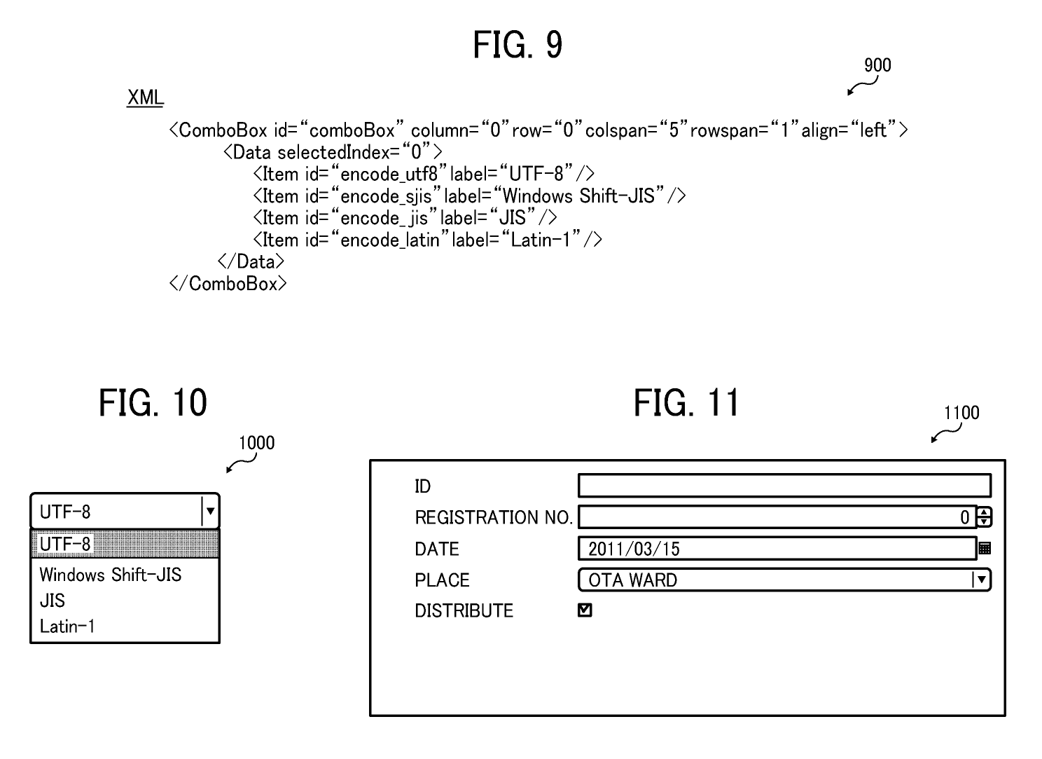

FIG. 8 illustrates UI data 810 to be interpreted based on UI control data, and a UI 840 that is displayed on a screen based on the UI data 810, according to an example embodiment of the present invention. The UI 840 includes an input field 850 for entering a user name or a user ID, and an input field 860 for entering a department to which the user belongs. The UI data 810 includes an attribute value, which controls display of each of the input fields 850 and 860. As indicated by the value of the attribute “acl” 820, the input field 850 (“Input your name”) is authorized to the group A and the group B. As indicated by the value of the attribute “acl” 830, the input field 860 (“Input your department”) is authorized to only the group A.

In case the user of the group A accesses a user interface, the user interface 840 being displayed to the user of the group A includes the input field 850 and the input field 860 as illustrated in FIG. 8, based on the UI data 800. In case the user of the group B accesses a user interface, the user interface 840 being displayed to the user of the group B does not include the input field 860, based on the UI data 800. Accordingly, a user interface to be displayed can be customized by specific user or by specific group.

In this example, any one of the UI part for entering the login user information and the UI part for entering the group information, which may be shared among a plurality of nodes, may be managed as a separate file such that each node can use the separate file without accessing the server 204. In case the UI part for the login user information and the UI part for the group information are separately managed, the node may combine the UI parts, for example, using the namespace, and displays the UI parts in the same UI screen.

Numerous additional modifications and variations are possible in light of the above teachings. It is therefore to be understood that within the scope of the appended claims, the disclosure of the present invention may be practiced otherwise than as specifically described herein.

With some embodiments of the present invention having thus been described, it will be obvious that the same may be varied in many ways. Such variations are not to be regarded as a departure from the spirit and scope of the present invention, and all such modifications are intended to be included within the scope of the present invention.

For example, elements and/or features of different illustrative embodiments may be combined with each other and/or substituted for each other within the scope of this disclosure and appended claims.

Further, any of the above-described devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory cards, ROM (read-only-memory), etc.

Alternatively, any one of the above-described and other methods of the present invention may be implemented by ASIC, prepared by interconnecting an appropriate network of conventional component circuits or by a combination thereof with one or more conventional general purpose microprocessors and/or signal processors programmed accordingly.

As described above, the server 204 dynamically changes a UI to be displayed at a specific apparatus in a workflow system, which includes various data items to be set at the specific apparatus. Through the UI, a user at the specific apparatus enters a value for each one of the data items being displayed, which may be later used by any apparatus in the workflow system to apply specific processing. The data items of the UI being displayed are dynamically changed so as to reflect various changes in the workflow system such as the change in workflow, the changes in functionality of one or more nodes in the workflow, or the change in functions that are authorized to a user or a group of users. More specifically, the server 204 generates UI data, and UI control data that controls display of the UI data, for each one of apparatuses functioning as a node in the workflow in a manner specific to a group of users or a user.

For example, the UI data and the UI control data may be generated in XML. The server 204 generates the UI data and the UI control data, based on node information of a specific node. The node information indicates, for example, a workflow to be processed, a workflow group assigned with the workflow, one or more users who belong to the workflow group. Each node in the workflow group refers to the UI control data to select the UI parts of the UI data to be displayed as a UI.

In one example, the present invention may reside in an information processing apparatus provided in a workflow system. The workflow system includes a plurality of data processing devices connected through a network, which perform a sequence of operations with respect to electronic data as defined by a workflow. The workflow may be defined specific to a group of users. The information processing apparatus includes: bibliographic data generating means for generating information that defines a function to be performed in the workflow; and a database that stores information regarding bibliographic items to be set at the data processing device, user identification information that uniquely identifies a user, group identification information that uniquely identifies a group to which the user belongs, and one or more authorized functions that are available to one or more devices assigned to the group. The bibliographic data generating means includes: bibliographic item obtaining means for obtaining one or more bibliographic items from the database based on the user identification information or the group identification information; and display data generating means for generating user interface data that causes the information processing apparatus to display user interface allowing the user to set the bibliographic items and user interface control data that controls display of the bibliographic items in the user interface.

For example, the bibliographic data generating means corresponds to the bibliographic data generator 322 of FIG. 3, which may be implemented by a processor in cooperation with a control program stored in a memory.

In one example, the present invention may reside in a recording medium storing a plurality of instructions, which cause a general-purpose computer to function as the above-described information processing apparatus. For example, the information processing apparatus may function as a server with respect to the plurality of data processing devices.

The UI data and the UI control data, which are referred to by the information processing apparatus to display the user interface, are written in XML. For example, the UI data is XML schema using a namespace.

In another example, the present invention may reside in a non-transitory recording medium storing a plurality of instructions which, when executed by a processor, cause the processor to function as the above-described information processing apparatus. For example, the plurality of instructions may be implemented as a set of software components that adds specific functionality to the existing application, such as a plug-in or add-on.

What is claimed is:

1. A display control apparatus that controls display of a user interface at a node apparatus functioning as a node in a workflow system, the display control apparatus comprising:
a memory to store authorized function information indicating one or more authorized functions of a plurality of data processing devices in the workflow system that are authorized for use by a user or a group of users, and information indicating one or more bibliographic data items that reflect the one or more authorized functions; and
a processor to:
define a workflow to be processed by the workflow system, the workflow indicating a plurality of functions that are sequentially or concurrently performed by one or more of the plurality of data processing devices in the workflow system to process electronic data;
obtain user identification information of a user at the node apparatus from the node apparatus;
obtain group identification information of a workflow group to which the user belongs, using the authorized function information;
specify one or more functions that are authorized for use by the workflow group using the authorized function information, as authorized functions of the workflow group;
extract one or more user interface parts that reflect one or more bibliographic data items corresponding to the authorized functions, using the information indicating one or more bibliographic data items; and
generate user interface data that causes the node apparatus to display a user interface including the extracted user interface parts to allow the user to set values of the bibliographic data items corresponding to the authorized functions, and user interface control data that controls display of the extracted user interface parts in the user interface.

2. The display control apparatus of claim 1, wherein the authorized function information includes, for each one of a plurality of workflow groups, user identification information that uniquely identifies a user who belongs to the workflow group, and one or more functions that are authorized for use by the workflow group.

3. The display control apparatus of claim 2, further comprising:
a network interface to transmit at least one of the user interface data and the user interface control data to the node apparatus through a network at one of the times including: the time when a request is received from the node apparatus, the time when the authorized function information is changed, and the time when a predetermined time period elapses.

4. The display control apparatus of claim 2, wherein the display control apparatus is an information processing apparatus functioning as a server, and the node apparatus is an image processing apparatus functioning as a client.

5. The display control apparatus of claim 4, wherein the user interface data and the user interface control data are written in XML.

6. The display control apparatus of claim 5, wherein the user interface data is XML schema using a namespace.

7. A display control method of controlling display of a user interface at a node apparatus functioning as a node in a workflow system, the display control method comprising:
storing, in a memory, authorized function information indicating one or more authorized functions of a plurality of data processing devices in the workflow system that are authorized for use by a user or a group of users, and information indicating one or more bibliographic data items that reflect the one or more authorized functions;
defining a workflow to be processed by the workflow system, the workflow indicating a plurality of functions that are sequentially or concurrently performed by one or more of the plurality of data processing devices in the workflow system to process electronic data;
obtaining user identification information of a user at the node apparatus from the node apparatus;
obtaining group identification information of a workflow group to which the user belongs, using the authorized function information;
specifying one or more functions that are authorized for use by the workflow group using the authorized function information, as authorized functions of the workflow group;
extracting one or more user interface parts that reflect one or more bibliographic data items corresponding to the authorized functions, using the information indicating one or more bibliographic data items; and
generating user interface data that causes the node apparatus to display a user interface including the extracted user interface parts to allow the user to set values of the bibliographic data items corresponding to the authorized functions, and user interface control data that controls display of the extracted user interface parts in the user interface.

8. The display control method of claim 7, wherein the authorized function information includes, for each one of a plurality of workflow groups, user identification information that uniquely identifies a user who belongs to the workflow group, and one or more functions that are authorized for use by the workflow group.

9. The display control method of claim 8, further comprising:
transmitting at least one of the user interface data and the user interface control data to the node apparatus through a network at one of the times including: the time when a request is received from the node apparatus, the time when the authorized function information is changed, and the time when a predetermined time period elapses.

10. The display control method of claim 8, wherein the user interface data and the user interface control data are written in XML.

11. The display control method of claim 10, wherein the user interface data is XML schema using a namespace.

12. A non-transitory recording medium storing a plurality of instructions which, when executed by a processor, cause the processor to perform a display control method comprising:
storing, in a memory, authorized function information indicating one or more authorized functions of a plurality of data processing devices in the workflow system that are authorized for use by a user or a group of users, and information indicating one or more bibliographic data items that reflect the one or more authorized functions;
defining a workflow to be processed by the workflow system, the workflow indicating a plurality of functions that are sequentially or concurrently performed by one or more of the plurality of data processing devices in the workflow system to process electronic data;
obtaining user identification information of a user at the node apparatus from the node apparatus;
obtaining group identification information of a workflow group to which the user belongs, using the authorized function information;
specifying one or more functions that are authorized for use by the workflow group using the authorized function information, as authorized functions of the workflow group;
extracting one or more user interface parts that reflect one or more bibliographic data items corresponding to the authorized functions, using the information indicating one or more bibliographic data items; and
generating user interface data that causes the node apparatus to display a user interface including the extracted user interface parts to allow the user to set values of the bibliographic data items corresponding to the authorized functions, and user interface control data that controls display of the extracted user interface parts in the user interface.

13. The non-transitory recording medium of claim 12, wherein the authorized function information includes, for each one of a plurality of workflow groups, user identification information that uniquely identifies a user who belongs to the workflow group, and one or more functions that are authorized for use by the workflow group.

14. The non-transitory recording medium of claim 13, wherein the display control method further comprises:
transmitting at least one of the user interface data and the user interface control data to the node apparatus through a network at one of the times including: the time when a request is received from the node apparatus, the time when the authorized function information is changed, and the time when a predetermined time period elapses.
